(19) United States
(12) Patent Application Publication
(10) Pub. No.: US 2025/0382541 A1
(43) Pub. Date: Dec. 18, 2025

(54) METHOD OF MAKING A GEL WAX CANDLE, SETTING, OR CENTERPIECE HAVING OBJECTS SUSPENDED IN THE GEL WAX

(71) Applicant: Humera Engle, Manassas, VA (US)

(72) Inventor: Humera Engle, Manassas, VA (US)

(21) Appl. No.: 18/746,229

(22) Filed: Jun. 18, 2024

(51) Int. Cl. C11C 5/00; C08L 91/06

(52) U.S. Cl. CPC C11C 5/008; C08L 91/06; C11C 5/002

(57) ABSTRACT

A gel wax candle, setting, or centerpiece is made by pouring gel wax into a container and allowing it to harden, and then reheating the hardened gel wax to a temperature sufficient to partially melt the gel wax and thereby allow objects placed on a top surface of the gel wax to sink into the gel wax by a predetermined amount that depends on the density or viscosity of the gel wax, and the shape, size, composition and/or weight of the objects.

### BACKGROUND OF THE INVENTION

### 1. Field of the Invention

The present invention relates to gel wax candles or centerpieces, and more particularly to a method of making gel wax candles having objects suspended therein for decorative effect.

Although the following description refers to candles, the principles of the invention may be applied to centerpieces, table settings, and any other gel wax arrangements.

### 2. Description of Related Art

Gel wax candles or centerpieces, in which liquid gel wax is poured into a glass or other transparent container, have become increasingly popular because of their customizability. Gel waxes are available in multiple colors, and have the ability to hold objects such as beads or seashells in suspension to achieve a variety of decorative effects. Because the gel wax melts at relatively low temperatures, gel wax candles may be easily and safely manufactured without specialized equipment, by anyone with a stove to heat the gel wax.

The gel waxes used in such candles or centerpieces are widely available for purchase by hobbyists, and numerous instructional videos are available on the Internet to assist home candle makers in the creation of attractive and professional looking gel wax candles. An example of a currently available instructional video showing a conventional method of making a gel wax candle or centerpiece can be found at https://www.youtube.com/watch?v=fytCPY2PzD4 and entitled “Beginner's Guide to Gel Wax Candles.” Other examples of gel wax candle making instructional videos can be accessed via the following hyperlinks:

https://www.youtube.com/watch?app=desktop&v=jAKGjCLBeR4
https://www.youtube.com/watch?v=7oAWQiEs3Go
https://www.youtube.com/watch?v=QRreoSXekyE
https://www.youtube.com/watch?v=_jGWnnoQu_U.

While the conventional methods are easy to practice and can result in attractive candles or centerpieces, it is difficult to suspend the objects at positions other than the floor of the candle or centerpiece. Positioning of the objects at locations above the floor of the container has conventionally required pouring a layer of gel wax into the container before placement of the objects, allowing the poured layer to cool until it solidifies, placing the objects on top of the solidified layer, and pouring additional wax layers to cover the objects so that they appear to be suspended. This limits the position of the suspended objects to the base of the container or the surface of the poured layer. While one can repeat the procedure for multiple layers, using a lower melting point wax above a layer of higher melting point wax to ensure that objects placed on the lower layer stay in place without sinking to the bottom of the container or affecting the uniformity of the lower gel wax layer or layers, the conventional methods are time-consuming and limit the positions at which the objects can be suspended. In addition, such arrangements are difficult to reproduce, and ill-suited to commercial or volume production.

In addition to the above-cited instructional videos, gel wax candles and methods of making them have been described in a number of patents and patent publication. For example, U.S. Pat. No. 6,680,014 discloses a candle with multiple gel wax layers having different melting temperatures, in which lower-temperature gel wax is poured a higher temperature gel wax layer to avoid mixing of the gel waxes, while a higher temperature gel wax layer is poured over a lower temperature gel wax layer to facilitate mixing. Ornaments may be placed at the bottom of any layer whose temperature is low enough to prevent damage to the objects, or the objects may be pre-coated with a higher temperature gel wax material for subsequent inclusion in a lower temperature gel wax layer.

Additional examples include U.S. Patent Publication No. 2004/0128879, which discloses forming a wax layer on top of a layer that remains liquid layer in which objects are free to float; Japanese Patent Publication No. JP 2014-47315, which discloses a gel candle in which an object can either be positioned at the base of the container and/or on top of a gel layer that is allowed to solidify before placement of additional objects on the solidified gel layer; U.S. Pat. No. 6,129,771, which shows glass spheres or “other objects” suspended in gel wax; and U.S. Pat. No. 6,033,210, which discloses “stones” or “beads” placed in a cavity and “secured in place” with a gelatinous component. Finally, U.S. Patent Publication No. 2002/0102507 discloses placing “marine life” objects in a “semi-dense” gel wax layer so that they “appear to be floating” in the gel wax layer.

Alternatively, instead of positioning object with poured a gel wax, candle makers have attempted to create the illusion of suspended objects by gluing objects to the side of the container, as disclosed for example in U.S. Pat. No. 6,033,210, or by placing a candle jar within another candle jar or sleeve in order to give the appearance of floating objects, as disclosed for example in U.S. Patent Publication No. 2007/0134606.

In contrast, the present invention provides a gel wax candle making method that does not require pouring of multiple layers of gel wax, limit object placement to the bottom or side of the container, or require that the object be placed in an at least partially liquid, semi dense, or gelatinous material. Instead, according to the present invention, the objects are placed on the surface of gel wax that has been poured into a container and allowed to solidify, after which the entire container is placed in an oven to reheat and melt the gel wax sufficiently to allow the objects to sink, without having to be manually pushed, to a desired position. None of the prior videos, patents or patent publications discloses reheating of a gel wax layer to position in this manner.

One instructional gel-candle-making video, entitled “How to Combine Soy Wax and Gel Wax/Candle Making Ideas with Different Wax,” and available at https://www.youtube.com/watch?v=fytCPY2PzD4, does disclose reheating of gel wax to facilitate positioning of objects in the gel wax. However, instead of reheating the entire container and gel wax to a predetermined temperature by placing the container with the gel wax in an oven after placing the objects on the surface of the gel wax, the video discloses a modification of the conventional method in which the solidified gel wax layer is reheated by a heat gun so that the gel wax is softened or partially melted, allowing objects positioned on the surface of the reheated layer to be manually pushed into the gel wax. This use of a heat gun to reheat the gel wax, without first positioning the objects on the surface of the gel wax before heating, has a number of disadvantages, including the disadvantages that it difficult to control the location and degree of melting in the area where the objects are to be placed, and to maintain the uniform appearance of the wax through which the objects are pushed. In addition, use of a heat gun and manual positioning of the objects after reheating can present a safety hazard for an unskilled hobbyist.

It is also known to reheat gel was layers for purposes other than suspending objects, for example by using a heat gun or lighter to liquify the surface of the gel wax in order to facilitate removal of bubbles or, as disclosed U.S. Pat. No. 6,171,102, by reheating of a combined candle and gel wax filler material using a hair dryer “to round the structure as an inherent heat-induced reaction occurs in the gelatinous material for . . . sheen production.”

Finally, by way of general background concerning gel wax candles or centerpieces, U.S. Patent Publication No. 2002/0150854 discloses candles in which gel wax is poured over objects positioned at the bottom of the container, and a second gel wax layer is poured over the initial gel wax layer after placement of a wick; U.S. Pat. No. 6,592,637 is directed to a candle with multiple opaque and transparent wax layers; U.S. Pat. No. 6,171,101 discloses a candle with a solid bubble-containing gel wax structure arranged to float on a liquid.to provide a “unique candle glow effect”; U.S. Pat. No. 10,859,223 discloses a similar floating candle arrangement with a wax layer arranged to float on a “suspension layer” containing suspended objects; French Patent Publication FR2822930 discloses decorations immersed in a liquid and covered by a silicon layer, to which a wick is attached and over which “hot-melt fuel” is poured, and Korean Patent Publication (Word translation included with search results) discloses a candle with mixed gel wax and soy wax layers.

### SUMMARY OF THE INVENTION

It is accordingly a first objective of the invention to provide a method of making gel wax candles having objects suspended at desired depths, utilizing a method that can be carried out safely and easily using existing, readily available materials, and without special skills or equipment.

It is a second objective of the invention to provide a method of making gel wax candles that enables production of gel wax candles in which the positions of the objects can be predetermined based on such factors as the melting temperature of the gel wax, the size and shape of the objects, thereby enabling volume production of gel wax candles with substantially identical arrangements of suspended objects.

It is a third objective of the invention to provide a method of making gel wax candles that enables relatively precise positioning of suspended objects without have to pour multiple layers of gel wax.

These and other objectives are achieved, in accordance with the principles of a preferred embodiment of the invention by a method of suspending objects in a gel wax that involves reheating a previously solidified gel wax structure to a temperature sufficient to allow the objects to sink, in response to gravity and without additional manual intervention, into the gel wax and thereby become suspended at predetermined positions when the gel wax cools.

The method of the invention further involves finding a suitable gel wax composition and determining a temperature at which the gel wax becomes sufficiently liquified/viscous to enable the objects to sink by a desired amount before cooling occurs, as well as determination of the timing at which objects may be placed on the reheated gel wax in order to achieve the desired suspension.

According to an exemplary embodiment of the invention, a method of making a gel wax candle with suspended objects includes the steps of:
(a) heating a gel wax to a temperature sufficient to melt the gel wax and pouring it into an at least partially transparent container so that the gel wax is visible from outside the container and the gel wax is present in a portion of the container;
(b) letting the gel wax cool and harden;
(c) placing objects on top of the hardened gel wax;
(d) applying heat to the container, for example by placing it in an oven, to reheat the hardened gel wax to a temperature that liquifies the gel wax sufficiently to enable the objects to break through the top layer of gel wax after a predetermined period;
(e) placing a second layer of objects on the top layer of the gel wax and continuing to apply heat to the container, causing the second layer of objects to break through the top layer of the gel wax as the first layer continues to move downwardly;
(f) repeating step (e) until a desired number of layers have been positioned; and
(g) cooling the container to prevent further movement of the layers of objects.

Preferably, the gel wax is a high density gel wax having a melting point that is sufficiently low that it can be melted on a stovetop. The use of high density gel wax is preferred because it slows the movement of the objects within the gel wax, enabling the objects to sink to the desired position and no further as the gel wax cools. High density gel waxes with appropriate properties, include a relatively low melting temperature for convenience and safety, are widely available at hobby shops and through on-line vendors. An example is the high density gel wax sold by Heigble.

The objects to be suspended in the gel wax can include any objects that are not damaged at the relatively low temperatures necessary to soften the gel wax by an amount sufficient to allow the objects to sink, including glass or ceramic beads, sea shells, pebbles, and the like. The types or shapes of the objects form no part of the present invention, nor is the invention limited to a particular type of container, so long as the container can withstand the relatively low temperatures necessary to pour or reheat the gel wax, and so long as the gel wax and objects suspended therein are visible from outside the container. Examples of suitable containers include glass jars and drinking glasses of various shapes, materials, and degrees of transparency or translucence.

Following suspension of the objects by reheating and then cooling of the gel wax, it is within the scope of the invention but not required to perform such additional steps as reheating the surface of the gel wax using a heat gun to remove ripples and bubbles, and adding additional layers such as a white or soy wax layer in which a candle wick is positioned.

These and other features and advantages may be understood in connection with the following description of exemplary embodiments of the invention, with reference to the appended drawings.

### BRIEF DESCRIPTION OF THE DRAWINGS

FIG. 1 is a schematic diagram illustrating the first step of a method of making a gel wax candle or centerpiece according to an exemplary embodiment of the invention.

FIG. 2 is a schematic diagram illustrating a second step of the exemplary method.

FIG. 3 is a schematic diagram illustrating a third step of the exemplary method.

FIG. 4 is a schematic diagram illustrating a fourth step of the exemplary method.

FIG. 5 is a schematic diagram illustrating a fifth step of the exemplary method.

FIG. 6 is a schematic diagram illustrating a sixth step of the exemplary method.

### DETAILED DESCRIPTION OF THE PREFERRED EMBODIMENTS

As shown in FIGS. 1-6, which illustrate an exemplary embodiment of the invention, a gel candle or centerpiece is made by pouring gel wax 1 into a container 2 and reheating the gel wax 1, after it has cooled and solidified, to a temperature sufficient to partially melt the gel wax by an amount sufficient to allow objects 3 placed on a top surface 4 of the gel wax 1 to sink into the gel wax by a predetermined amount. The predetermined amount depends on the density or viscosity of the gel wax, and properties of the objects such as shape, size, composition, and/or weight. In addition, objects may be placed on the top surface 4 of the gel wax before beginning reheating and/or after the reheating has begun.

The temperature sufficient to allow the objects to sink into the gel wax, and thereby become suspended when the gel wax cools, may be determined by routine experimentation involving heating gel wax compositions, placing objects on the gel wax, and determining the temperature at which the gel wax becomes sufficiently liquified/viscous to enable the objects to sink by a desired amount to a desired position before cooling occurs. As part of the testing or experimentation, the timing at which objects are placed on the reheated gel wax in order to achieve the desired suspension.

To give specific examples, the gel wax 1 may initially be heated to 275° F. in order to completely melt the wax so that it is uniform when poured into the container, with pouring carried out at a temperature of 185° F. The gel wax may be left to cool and harden for 30 minutes to 12 hours.

More specifically, according to a preferred embodiment of the invention, a method of making a gel wax candle with suspended objects may include the following steps:

First, as illustrated in FIG. 1, a predetermined amount of gel wax 1 is heated to a temperature sufficient to melt the gel wax, and the melted gel wax is poured into an at least partially transparent container 2 that is sufficiently transparent to allow the gel wax to be seen from outside the container.

In the exemplary embodiment, the gel wax 1 is a high density gel wax having a melting point that is sufficiently low that it can be melted on a stovetop. By “high density” gel wax is meant a gel wax that is sufficiently dense that objects will not immediately sink to the bottom of the container upon reheating, but rather will sink slowly to a desired position as the gel wax cools and hardens and the object can no longer move. Suitable high density gel waxes are well known and available at hobby shops and on-line vendors. Use of a high density gel wax is preferred because, the slower the movement of the objects, the less likely there will be blemishes in the design, and also because if objects move to quickly in the gel wax, irritation forms causing trapped bubbles.

The container 2 may, by way of example and not limitation, be a votive centerpiece candle glass, although those skilled in the art will appreciate that the container 2 may be varied in numerous ways without departing from the scope of the invention.

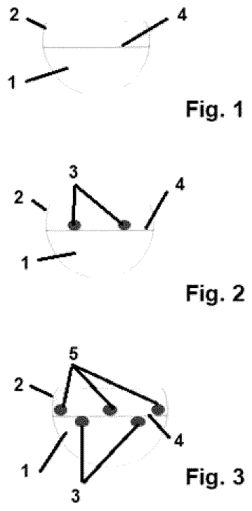

As shown in FIG. 2, after the gel wax 1 poured into the container 2 cools and solidifies, the objects 3 may be placed on a top surface 4 of the hardened gel wax. Those skilled in the art will appreciate that a variety of different objects 3 may be utilized, including by way of example and not limitation, glass beads, glass or ceramic objects in a variety of shapes, plastic objects, and/or natural objects such as sea shells and pebbles, so long as the objects can withstand the temperature to which the gel wax is reheated.

The gel wax 1 is then reheated until the wax starts to liquify allowing the objects to sink to the position shown in FIG. 3. The initial reheating step may, by way of example and not limitation, be carried out by placing the container in an oven preheated to a temperature of 170° F. to 230° F., depending on the exact composition of the gel wax, and the weight and shape of the objects. Those skilled in the art will appreciate that finding the most desirable temperature may involve routine experimentation involving heating samples to different temperatures and observing the movements of objects in the samples until a desired result is achieved.

If the objects 3 are glass beads, then after reheating for 25-45 minutes, the objects will break through the top layer 4 of the gel wax 1. At that point, additional objects 5 may be placed on the top surface 4 of the gel wax 1, for example by taking the container 2 out of the oven and placing the second layer of objects 5 on the surface 4 and then immediately returning the gel wax to the oven. After another 5 to 15 minutes, the additional layer of objects 5 will break through the top layer 4 of the gel wax while the objects 3 continue to move downwardly. This allows a variety of objects 3 and 5 to be positioned at different depths.

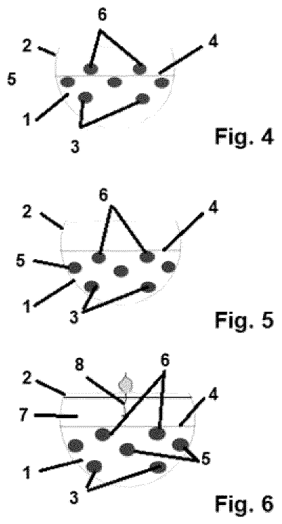

As shown in FIGS. 4 and 5, this process may be repeated until a desired effect involving multiple layers of objects 3, 5, and 6 is achieved. For example, if the third layer of objects 6 also consists of glass beads and the temperature of 170° F. to 230° F. is maintained, the third layer of objects 6 will break through the top surface 4 after another 3 to 7 minutes.

When the last desired layer of objects 3 has been position, reheating is terminated and the container 2 and gel wax 1 are allowed to cool, preferably by placing the container 2 in a refrigerator or freezer (not shown) to expedite cooling and thereby prevent further movement of the layers of objects 3, 5, and 6. As noted above, the layers of objects may each have different types of objects or the same type of objects, and objects within the layers may also be the same or different.

FIG. 5 shows an arrangement in which each of the layers of objects 3, 5, 6 and 6 has been allowed to sink below the top surface 4. It is also possible to leave a layer on the top surface by terminating reheating before the last layer is positioned. In addition, while FIGS. 3 to 5 show arrangements in which each of the objects in a layer sinks to the same level, if the objects in a layer are non-uniform, objects within a layer may sink to different depths depending on the composition, shape, and density or weight of the objects.

After completion of the reheating steps, the positions of the objects may be further adjusted by localized reheating of the gel wax 1, using a lighter, heat gun, high temperature lamp or other localized heat source. The lighter, heat gun, or high temperature lamp can also be used to remove ripples, bubbles, or discontinuities in the gel wax, if desired.

Finally, as illustrated in FIG. 6, the method of the invention may further include the optional step of topping the cooled gel wax 1 with a layer 7 of white wax or soy wax having a melting point that is lower than the melting point of the gel wax to enable the white or soy wax to be poured onto the top surface 4 of the gel wax without melting the gel wax and affecting the gel wax suspension. To complete the candle, a wick 8 may be positioned in the white or soy wax layer 7 according to well-known candle forming methods.

Although preferred embodiments of the invention have been described in connection with the appended drawings, it will be appreciated by those skilled in the art that the description of the preferred embodiments is not intended to be limiting. For example, multiple layers with different types of gel wax may be included. Also, additional objects may be positioned at the base of the container 2 before any gel wax is poured. As a result, it is intended that the invention not be limited to the specific embodiments described herein, but rather that the illustrated embodiments may be varied without departing from the scope of the invention, which should be limited solely by the appended claims

What is claimed is:

1. A method of making a candle, setting, or centerpiece including at least one layer of gel wax and objects suspended at predetermined positions in the gel wax, comprising the steps of:
heating the gel wax to a temperature sufficient to melt the gel wax and pouring the melted gel wax into an at least partially transparent container so that the gel wax is visible from outside the container;
allowing the gel wax in the container to cool and harden;
placing objects on a top surface of the cooled and hardened gel wax;
applying heat to the container to reheat the hardened gel wax to a temperature that liquifies the gel wax sufficiently to enable the objects to break through the top layer of gel wax after a predetermined period;
terminating application of heat to the container and cooling the container to prevent further movement of the layers of objects.

2. The method of making a gel wax candle, setting, or centerpiece as claimed in claim 1, further comprising the step of placing a second layer of objects on the top layer of the gel wax and continuing to apply heat to the container, causing the second layer of objects to break through the top layer of the gel wax as the first layer continues to move downwardly.

3. The method of making a gel wax candle, setting, or centerpiece as claimed in claim 2, further comprising the step of placing a third layer of objects on the top layer of the gel wax and allowing the third layer of objects to break through the top layer of the gel wax as the first and second layers continue to move downwardly.

4. The method of making a gel wax candle, setting, or centerpiece as claimed in claim 1, wherein the temperature that liquifies the gel wax is 170° F. to 230° F.

5. The method of making a gel wax candle, setting, or centerpiece as claimed in claim 1, wherein the gel wax is high density gel wax.

6. The method of making a gel wax candle, setting, or centerpiece as claimed in claim 1, wherein the step of applying heat to the container is carried out by placing the container with the initially hardened gel wax in an oven preheated to the desired temperature.

7. The method of making a gel wax candle, setting, or centerpiece as claimed in claim 1, wherein cooling to harden the gel wax and stop movement of the objects may be achieved by placing the container in a refrigeration unit or refrigerator.

8. The method of making a gel wax candle, setting, or centerpiece as claimed in claim 1, further comprising the step of utilizing a heat gun or other localized heat source to remove ripples, bubbles, or discontinuities in the gel wax.

9. The method of making a gel wax candle, setting, or centerpiece as claimed in claim 1, further comprising the step of forming a white or soy wax layer on the top surface of the gel wax layer after the step of terminating application of heat to the container and cooling the container to prevent further movement of the layers of objects.

10. The method of making a gel wax candle, setting, or centerpiece as claimed in claim 8, wherein the step of forming the white or soy wax layer comprises the step of positioning a candle wick in the white or soy wax layer.
